(19) United States
(12) Patent Application Publication
(10) Pub. No.: US 2014/0089886 A1
(43) Pub. Date: Mar. 27, 2014

(54) USING MULTIPLE TECHNICAL WRITERS TO PRODUCE A SPECIFIED SOFTWARE DOCUMENTATION PACKAGE

(71) Applicant: INTERNATIONAL BUSINESS MACHINES CORPORATION, Armonk, NY (US)

(72) Inventors: Valentina Salapura, Chappaqua, NY (US); Maja Vukovic, New York, NY (US)

(73) Assignee: INTERNATIONAL BUSINESS MACHINES CORPORATION, Armonk, NY (US)

(21) Appl. No.: 13/655,988

(22) Filed: Oct. 19, 2012

Related U.S. Application Data
(63) Continuation of application No. 13/628,639, filed on Sep. 27, 2012.

(51) Int. Cl. G06F 9/44

(52) U.S. Cl. 717/101

(57) ABSTRACT

An embodiment of the invention produces software documentation that includes first and second sections. Skills a technical writer needs are determined, wherein preparation of the first and second sections require different skill sets. A database is searched to select technical writers qualified to prepare each of the multiple document sections, wherein the database contains the identities and qualifications of persons qualified to be technical writers. Preparation of the first and second sections are then assigned to first and second writers having first and second skill sets, respectively. Each prepared section is validated for incorporation into the software documentation.

This application is a continuation of and claims the benefit of priority to U.S. patent application Ser. No. 13/628,639, filed on Sep. 27, 2012, status Pending, and entitled “Using Multiple Technical Writers to Produce a Specified Software Documentation Package”. The contents of which are hereby incorporated by reference.

### BACKGROUND

1. Field

The invention disclosed and claimed herein pertains to a method for preparing a specified software documentation package or the like, wherein different types of technical expertise, or skill sets, are required to prepare different modules or sections of the documentation. More particularly, the invention pertains to a method of the above type that includes discovering or identifying technical writers that possess each of the different required skill sets.

2. Description of the Related Art

Software related products typically must be accompanied by software documentation packages of some type. These include, by way of example and not limitation, user manuals, design and architecture descriptions, programming guides, service manuals and guides, advertising and promotional materials and “tips and tricks”. Some of these documentation packages can be very large, and pertain to complex software systems and projects.

At present, it often happens that a technical writer tasked to prepare documentation of the above type does not have a sufficient level of expertise and understanding for all the associated material. This situation, of course, diminishes the quality level of the produced documentation. Also, this situation is especially likely to occur in connection with a document package that is very extensive, and includes multiple sections that require different types of technical expertise.

To overcome these deficiencies, technical writers may continually seek input or assistance from available subject matter experts (SMEs). However, this tends to reduce productivity of the overall process and can introduce disruption. For certain complex software systems and projects, preparation of the required documentation can require collaboration of a large global team. This is because few people are typically available who have sufficient expertise to handle the entire documentation. This, however, can result in different writing styles and disconnected content.

### SUMMARY

Embodiments of the invention produce a software documentation package as described above, wherein multiple authors or technical writers, who have expertise in different specified technical fields, are identified and used to draft different sections of the documentation package. Embodiments may also coordinate collaboration among respective writers.

One embodiment is directed to a computer implemented method for producing a specified software documentation package that comprises multiple document sections, including at least a first section and a second section. The method includes the step of determining a set of skills that a technical writer must have in order to prepare a given one of the documents sections, wherein preparation of the first section requires a first skill set, and preparation of the second section requires a second skill set that is different from the first skill set. The method further includes searching a specified database to select a technical writer qualified to prepare each section of the multiple document sections, wherein the specified database contains the identities of persons qualified to be technical writers, and further contains the technical writing qualifications of each person. Preparation of a given document section is then assigned to the technical writer selected for the given document section, wherein preparation of the first and second sections are assigned, respectively, to a first writer having the first skill set, and to a second writer having the second skill set. The method further includes validating each prepared component for incorporation into the software documentation package.

### BRIEF DESCRIPTION OF THE SEVERAL VIEWS OF THE DRAWINGS

FIG. 1 is a schematic diagram depicting components for an embodiment of the invention.

FIG. 2 is a flowchart depicting a process for a component of FIG. 1.

FIG. 3 is a flowchart depicting a process for a further component of FIG. 1.

FIG. 4 is a schematic diagram of a template for defining certain tasks in an embodiment of the invention.

FIG. 5 is a flowchart showing steps for a method comprising an embodiment of the invention.

FIG. 6 is a block diagram showing a network of data processing systems in which an embodiment of the invention may be implemented.

FIG. 7 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

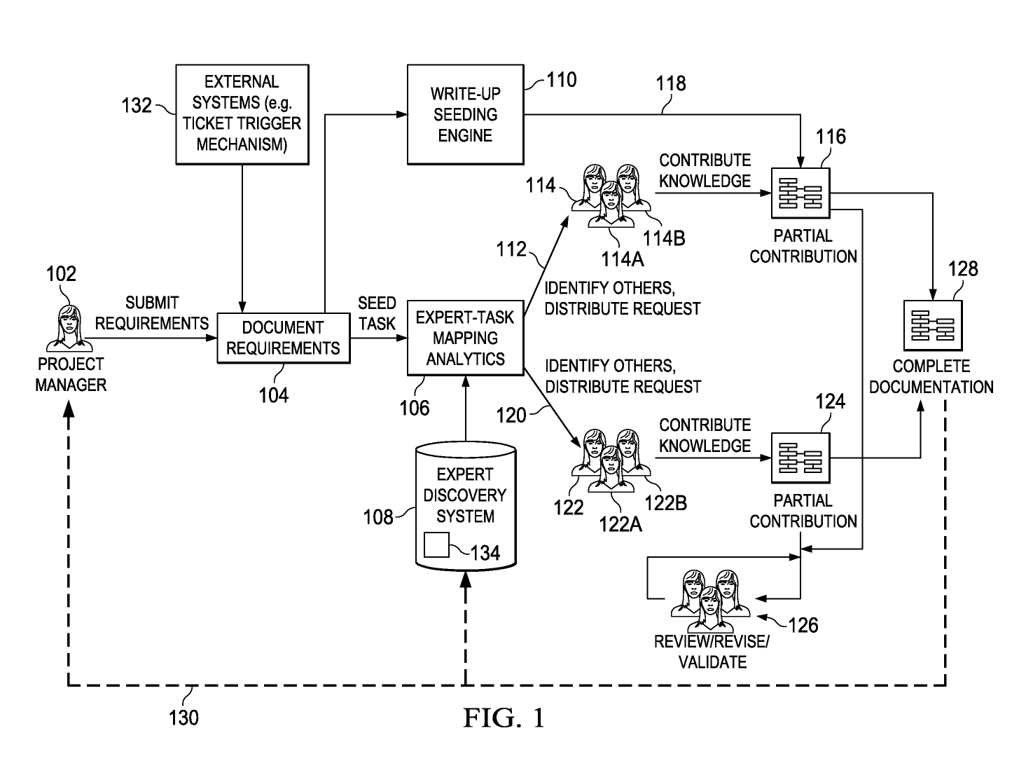

Referring to FIG. 1, there are shown components arranged to carry out respective tasks in an embodiment of the invention. The embodiment is directed to a process for creating a software documentation package, of a type such as those described above, wherein the documentation package comprises multiple sections or modules. Different sections pertain to significantly different technical areas. Thus, different types of technical expertise are required in order to write or create respective different sections.

The process of FIG. 1 commences with a project manager 102. The project manager initially defines the requirements 104 of the particular documentation that is to be prepared. The project manager also determines or breaks down the specific tasks that must be performed in preparing the documentation, describes respective task objectives, and defines dependencies that certain tasks have on other tasks. Usefully, each defined task comprises writing a section or module of the documentation that pertains to a particular type or field of technical expertise. A further role of the project manager 102 is to define the required expertise, or skill set requirements, that a technical writer must have in order to be assigned to a particular one of such writing tasks.

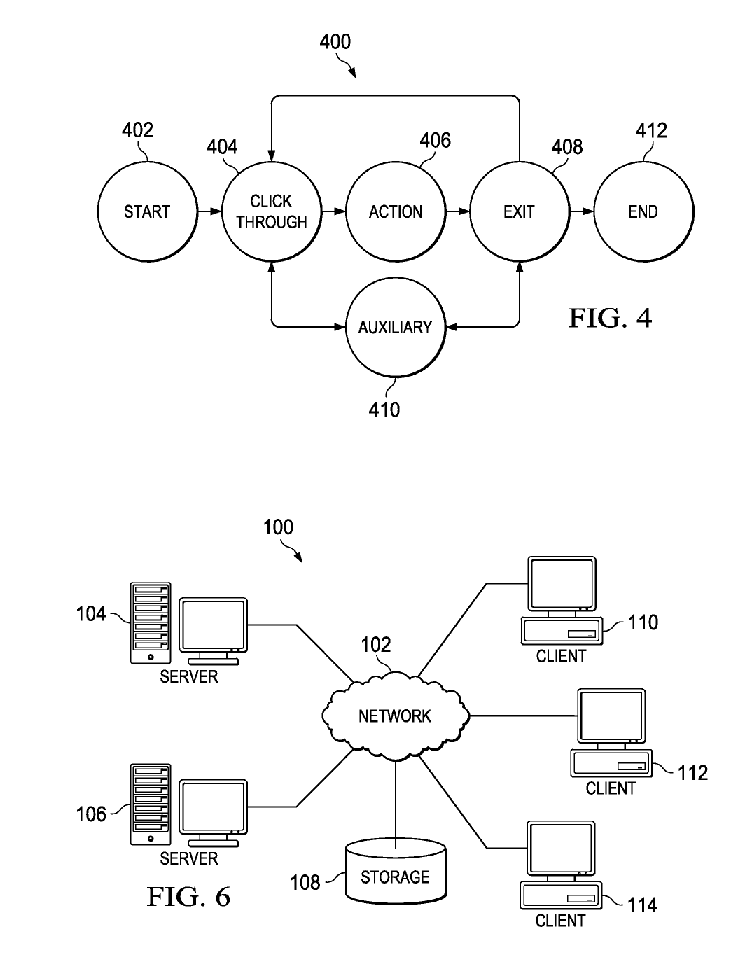

Project manager 102 could also select an existing template for use in creating the documentation package. The selected template would be a document that was used previously to generate similar or related documentation, and would have some or all of the requirements described above embedded into it. These embedded requirements could then be used to furnish some or all of the document requirements 104. Alternatively, if an existing template is not available, the project manager 102 may construct a new template, using requirements which she or he has defined for the current documentation project. Examples of templates are provided hereinafter, in connection with FIG. 4.

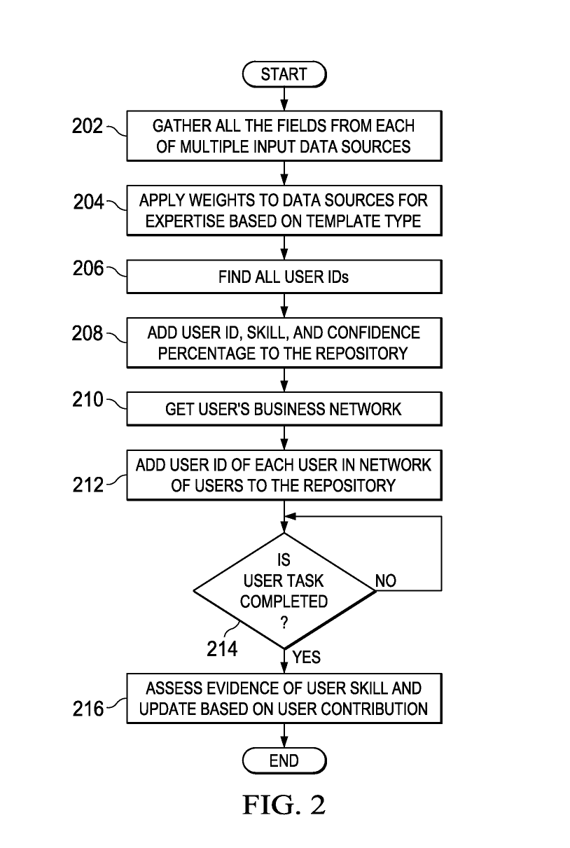

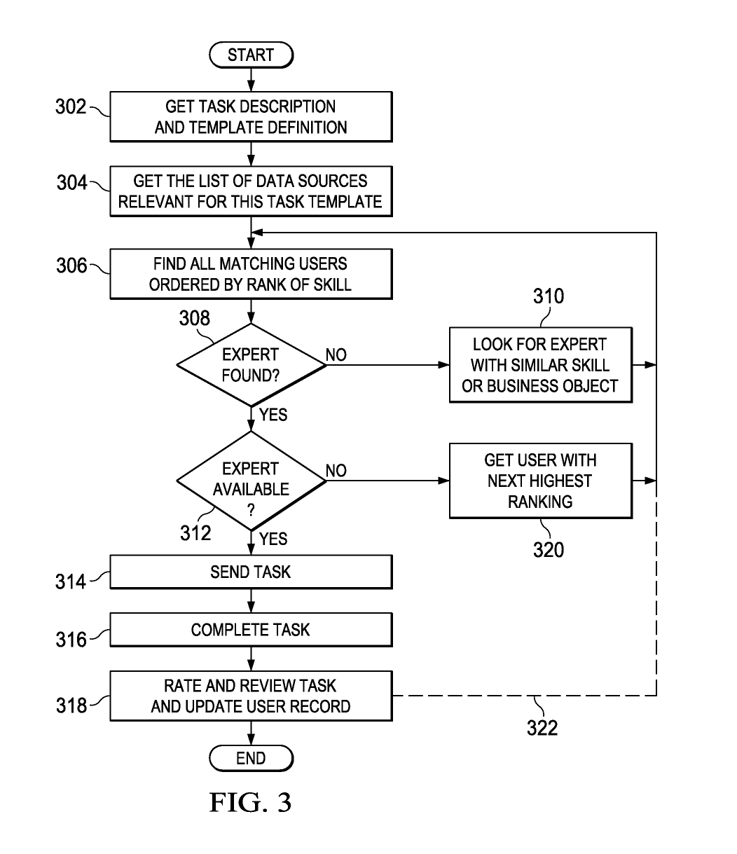

As described above, an important subset of the requirements 104 are the requirements which define the expertise or set of skills that a technical writer must have, for each documentation module writing task. Accordingly, FIG. 1 shows these writing tasks to be respectively seeded or delivered to an expert task mapping analytics engine 106. As is described hereinafter in further detail in connection with FIG. 3, engine 106 is operable to locate expert writers, and match them to respective writing tasks for which they are qualified. Analytics engine 106 works in relationship with an expert discovery system 108, described hereinafter in connection with FIG. 2.

Referring further to FIG. 1, there is shown a seeding engine 110 that could have a role in preparing or writing documentation. For example, there may be an existing document that includes some of the elements or sections needed for the documentation which is to be prepared. By furnishing the existing document to the seeding engine 110, a writer of the documentation could access the needed elements therefrom, as required. In some embodiments of the invention, seeding engine 110 could receive existing documents from sources such as online blogs, forums, Twitter or the World Wide Web. Appropriate existing documents can be found by crawling through online content.

FIG. 1 shows that a writing task 112 is assigned by expert mapping analytics engine 106 to a writer 114. Thus, writer 114 has been determined by engine 106 to have the requisite technical expertise for task 112. Writer 114 may further break down the assigned writing task into multiple subtasks, and assign a subtask to each of the writers 114a and 114b.

Writers 114, 114a and 114b collectively prepare the documentation module or section associated with task 112, in order to produce a partial contribution 116 for the documentation. This effort may include acquiring some pre-existing material 118 for the contribution 116 from seeding engine 110.

Similarly, a writing task 120 is assigned to technical writer 122, and then divided into subtasks, some of which are given to writers 122a and 122b. Writers 122, 122a and 122b collectively prepare the documentation section associated with task 120, in order to produce a partial contribution 124 for the documentation.

Each written contribution or section for the documentation is reviewed, revised and validated by another set of experts 126. The respective sections are then consolidated or aggregated into a complete documentation package 128, which may be further validated if needed. The reviewers may provide comments or suggest new or additional sections for the documentation. New sections may also be indicated by an external system 132, such as by triggering a service ticket or the like.

FIG. 1 further shows a feedback loop 130, which routes information pertaining to completed documentation package 128 back to project manager 102. This feedback may automatically trigger changes that should be made to documents based on the completed documentation, such as underlying code changes, or project scope changes. The feedback loop 130 may also be routed to expert discovery system 108, as described hereinafter in further detail.

Referring to FIG. 2, there is shown a flowchart depicting steps of a process for creating or constructing a database that contains the identities and qualifications of persons having various types of technical writing skills. The process of FIG. 2 can be used to furnish such information to a database or repository, such as repository 134 of expert discovery system 108 of FIG. 1. The contents of repository 134 can then be accessed to identify and select appropriate technical writers, who will prepare respective sections of software documentation as described above. Identified persons are generically referred to as users in FIG. 2.

The construction process of FIG. 2 selects persons for database 134, and also provides their qualifications, on the basis of their documented prior experience and contributions, and also their association with other experts. At step 202, information is gathered that pertains to all the fields of multiple pertinent input data sources. These sources usefully include social networks and enterprise data repositories.

By way of example and not limitation, CVS and Jazz repositories could be accessed to determine the persons who developed a particular code. TAMe SSO logs could be used to find out who accessed which server and what commands were invoked, and which packages have been installed. A ticketing system could be used as a source to show a fixed one or more particular issues. For certain documents of interest, historical content could be accessed to determine who produced such documents.

At step 204, weights are applied to the different input data sources, according to the relevance that different sources have to the type of template that is being used to prepare the documentation package. Different types of templates are described hereinafter in further detail, in connection with FIG. 4. In a useful embodiment of the invention, each of a number of templates in repository 134 has an associated list of all data sources that are relevant to that template.

Identities for all users of respective input sources are found at step 206. At step 208, the identity of each user, together with the user's skill and a percentage level of confidence in the user, is added to repository 134. In one embodiment, each of the users that has a particular skill is ordered by rank of skill level.

At step 210, a business network is obtained for each user. The identity of each user found in a business network is added to repository 134 at step 212.

Decision step 214 queries whether a given user has completed a task that she or he was assigned, in preparing specified software documentation. If the answer to the query is affirmative, the process proceeds to step 216. In this step, the user's skill is assessed, and updated based on the user's contribution. Information provided by feedback loop 130 could be used for this purpose. The process of FIG. 2 then ends.

Referring to FIG. 3, there is shown a flowchart illustrating steps for a process of operating expert task mapping analytics engine 106. As described above, analytics engine 106 identifies expert technical writers who are qualified for tasks that comprise preparation of specified portions or sections of a documentation package. FIG. 3 focuses on a process of finding a single expert writer for a particular task, but the process of FIG. 3 may be repeated as needed to provide multiple expert writers.

At step 302, a description of the particular task, and a definition of the template associated with the documentation package, are made available. As described above, this information can be furnished by the project manager. At step 304, the list of data sources for the template, and more specifically for the data sources for the particular task, are acquired.

Step 306 is directed to locating each user in the acquired data sources who has skills and qualifications which match those required for the particular task. Located users are then ranked in an order determined by their respective skill levels.

Step 308 is a decision step which queries whether or not any experts were found at step 306. The output of step 308 is affirmative, if one or more users were located who each has the requisite skills and qualifications. The process of FIG. 3 then moves on to decision step 312, to consider the highest-ranked expert.

If the output of decision step 308 is negative, the process goes to step 310, which considers skills or business objects for an expert which are similar to the initially specified skills and qualifications. The process of FIG. 3 then returns to step 306, to locate users who match the similar skills or objects.

If decision step 312 determines that the expert found at step 308 is not available, the process goes to step 320. Step 320 chooses the user who had the next highest skill ranking, as described above in connection with step 306. The process then returns to step 306.

If the expert is determined to be available at step 312, the task is sent to the expert at step 314. At step 316, the expert completes the task, and at step 318 the task performance of the expert is reviewed and rated. Usefully, review and rating of the expert user are used to update the user's record in the data sources. This may be implemented, for example, by means of a feedback loop 322 directed back to step 306. In some embodiments of the invention, an expert who has completed a task can also suggest new topics or subtests.

Referring to FIG. 4, there is shown an exemplary template 400, which can be used in preparing software documentation of different types. Template 400 comprises nodes 402-412, which each comprises one or more steps as described hereinafter.

Start node 402 comprises a virtual step added to the head of each solution.

Click through node 404 comprises navigating steps that guide users to the core steps in a solution.

Action node 406 comprises course steps in a solution that actually change the settings or configurations.

Exit node 408 comprises steps that mark the end of the core steps.

Auxiliary node 410 comprises explanatory and other steps that do not fall into the previous three types.

End node 412 comprises another virtual step added to the end of each solution.

In one example, template 400 can be used to prepare software documentation that is directed to configuring a wireless network adapter on Macbook Air. Tasks for this documentation, which could require different technical writers, would include start initialization for a solution; and a set of steps to open the network settings.

In a further example, template 400 could be used to prepare software documentation for creating a new AIX instance. Tasks required for this documentation would include defining LPAR parameters; defining a pointer to a request form; and guidance for the configuration.

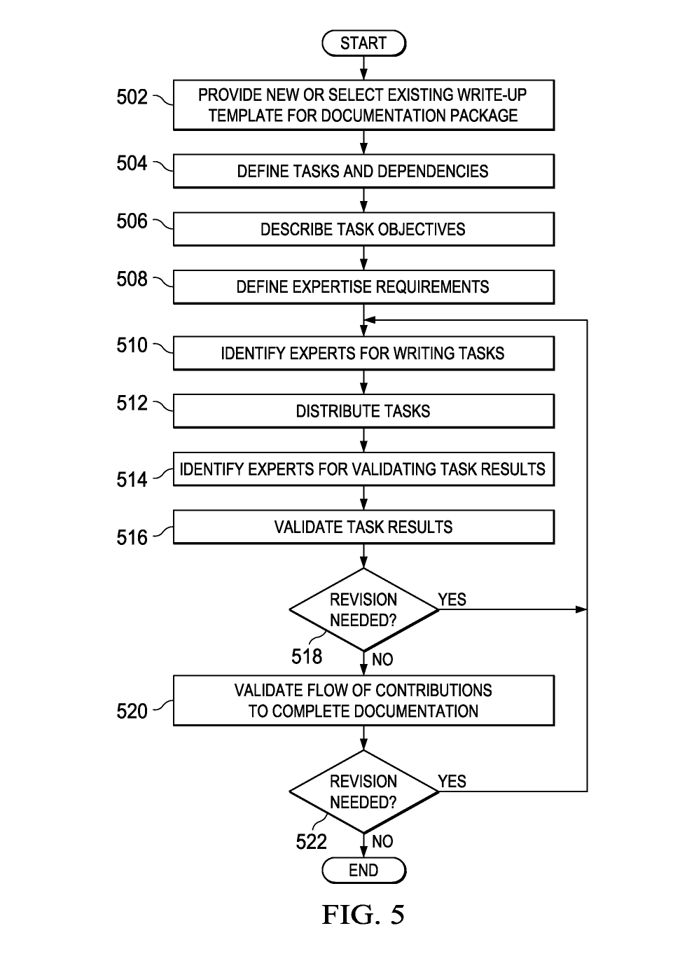

Referring to FIG. 5, there are shown steps for method comprising embodiment of the invention. As an initial step 502, a template is provided for use in creating a software documentation package. The template is usefully the template usefully specifies tasks and requirements for preparing respective sections of the documentation. As described above, the project manager could define or constructing new template for this purpose. Alternatively, the project manager could select an existing template that then that had been used previously. If the new template is created, it is usefully placed into a template repository, to be available for future use. If you previously used template is selected, it may need to be adapted or edited for the current use.

At steps 504-508, tasks and dependencies are defined, task objectives are described, and requirements for technical writing experts are defined, respectively. As described above, each of these tasks is usefully carried out by the project manager, for the specified documentation that is to be created.

Referring further to FIG. 5, experts for the writing tasks are identified at step 510, and tasks are distributed to the expert writers at step 512. Usefully, the steps are carried out by the expert discovery system 108 and analytics engine 106 described above. These components can also be used to identify experts for validating test results, in accordance with step 514. The test results are the documentation sections, the contributions, prepared by respective expert writers. The test results are validated at step 516.

Decision step 518 determines whether there is a need for revision of any of the task contributions, following step 516. If so, the method proceeds back to step 510, and otherwise proceeds to step 520. Step 520 validates the flow or aggregate purgation of respective contributions, to complete the documentation package. Decision step 522 determines whether any revision is then required, and if so the method proceeds back to step 510. If not, the method ends.

With reference now to the figures and, in particular, with reference to FIG. 6, an illustrative diagram of a data processing environment is provided in which illustrative embodiments may be implemented. It should be appreciated that FIG. 6 is only provided as an illustration of one implementation and is not intended to imply any limitation with regard to the environments in which different embodiments may be implemented. Many modifications to the depicted environments may be made.

FIG. 6 is a pictorial representation of a network of data processing systems in which illustrative embodiments may be implemented. Network data processing system 600 is a network of computers in which the illustrative embodiments may be implemented. Network data processing system 600 contains network 602, which is the medium used to provide communications links between various devices and computers connected together within network data processing system 600. Network 602 may include connections, such as wire, wireless communication links, or fiber optic cables.

In the depicted example, server computer 604 and server computer 606 connect to network 602 along with storage unit 608. In addition, client computers 610, 612, and 614 connect to network 602. Client computers 610, 612, and 614 may be, for example, personal computers or network computers. In the depicted example, server computer 604 provides information, such as boot files, operating system images, and applications to client computers 610, 612, and 614. Client computers 610, 612, and 614 are clients to server computer 604 in this example. Network data processing system 600 may include additional server computers, client computers, and other devices not shown.

Program code located in network data processing system 600 may be stored on a computer-recordable storage medium and downloaded to a data processing system or other device for use. For example, program code may be stored on a computer-recordable storage medium on server computer 604 and downloaded to client computer 610 over network 602 for use on client computer 610.

In the depicted example, network data processing system 600 is the Internet with network 602 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 600 also may be implemented as a number of different types of networks, such as, for example, an intranet, a local area network (LAN), or a wide area network (WAN). FIG. 6 is intended as an example, and not as an architectural limitation for the different illustrative embodiments.

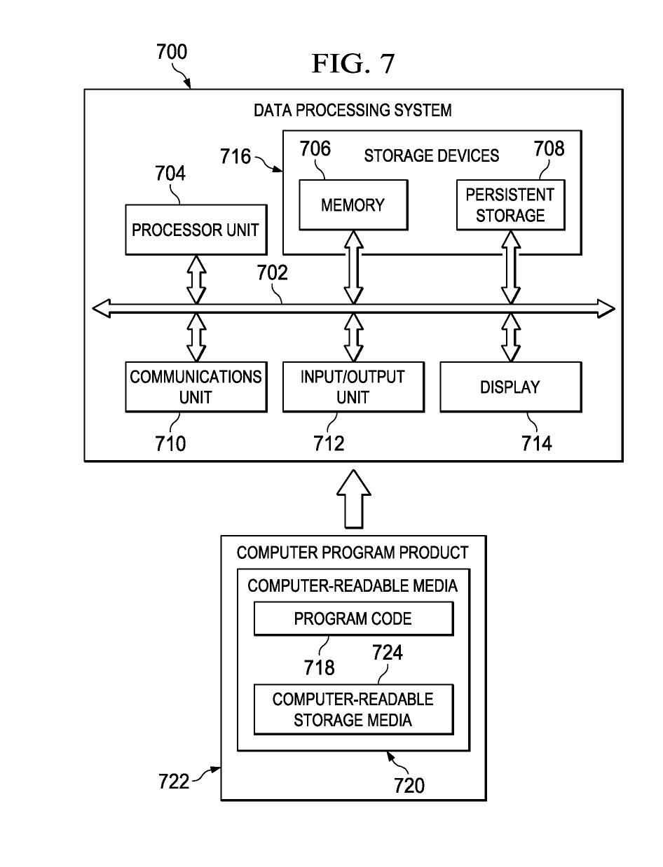

Turning now to FIG. 7, an illustration of a data processing system is depicted in accordance with an illustrative embodiment. In this illustrative example, data processing system 700 includes communications fabric 702, which provides communications between processor unit 704, memory 706, persistent storage 708, communications unit 710, input/output (I/O) unit 712, and display 714.

Processor unit 704 serves to execute instructions for software that may be loaded into memory 706. Processor unit 704 may be a number of processors, a multi-processor core, or some other type of processor, depending on the particular implementation. A number, as used herein with reference to an item, means one or more items. Further, processor unit 704 may be implemented using a number of heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer-readable storage devices in these examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications fabric 702. In these illustrative examples, the instructions are in a functional form on persistent storage 708. These instructions may be loaded into memory 706 for execution by processor unit 704. The processes of the different embodiments may be performed by processor unit 704 using computer implemented instructions, which may be located in a memory, such as memory 706.

These instructions are referred to as program code, computer-usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these examples. In one example, computer-readable media 720 may be computer-readable storage media 724. Computer-readable storage media 724 may include, for example, an optical or magnetic disk that is inserted or placed into a drive or other device that is part of persistent storage 708 for transfer onto a storage device, such as a hard drive, that is part of persistent storage 708. Computer-readable storage media 724 also may take the form of a persistent storage, such as a hard drive, a thumb drive, or a flash memory, that is connected to data processing system 700. In some instances, computer-readable storage media 724 may not be removable from data processing system 700.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 704 may take the form of a hardware unit that has circuits that are manufactured or configured for a particular use. This type of hardware may perform operations without needing program code to be loaded into a memory from a storage device to be configured to perform the operations.

For example, when processor unit 704 takes the form of a hardware unit, processor unit 704 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 718 may be omitted because the processes for the different embodiments are implemented in a hardware unit.

In still another illustrative example, processor unit 704 may be implemented using a combination of processors found in computers and hardware units. Processor unit 704 may have a number of hardware units and a number of processors that are configured to run program code 718. With this depicted example, some of the processes may be implemented in the number of hardware units, while other processes may be implemented in the number of processors.

As another example, a storage device in data processing system 700 is any hardware apparatus that may store data. Memory 706, persistent storage 708, and computer-readable media 720 are examples of storage devices in a tangible form. In another example, a bus system may be used to implement communications fabric 702 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 706, or a cache, such as found in an interface and memory controller hub that may be present in communications fabric 702.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer program product executable in a recordable storage medium for providing a specified software documentation package that comprises multiple document sections, including at least a first section and a second section, said computer program product comprising:
instructions for determining a set of skills that a technical writer must have in order to prepare a given one of said documents sections, wherein preparation of the first section requires a first skill set, and preparation of the second section requires a second skill set that is different from the first skill set;
instructions for searching a specified database to select a technical writer qualified to prepare each section of the multiple document sections, wherein the specified database contains the identities of persons qualified to be technical writers, and further contains the technical writing qualifications of each of said persons;
instructions for assigning preparation of a given document section to the technical writer selected for the given document section, wherein preparation of the first and second sections are assigned, respectively, to a first writer having the first skill set, and to a second writer having the second skill set; and
instructions for validating each prepared document section for incorporation into said software documentation package.

2. The computer program product of claim 1, wherein:
each prepared component is validated by one or more preselected subject matter experts (SMEs).

3. The computer program product of claim 2, wherein:
said SMEs require revision of a given prepared document section, before validating said given document section for incorporation into said software documentation package.

4. The computer program product of claim 1, wherein:
said computer program product pertains to a plurality of tasks, wherein each task comprises preparation of a different one of the multiple document sections, and performance of at least one of the tasks has a specified dependency on performance of another task.

5. The computer program product of claim 4, wherein:
one or more tasks are divided into subtasks, wherein each subtask is carried out by a different technical writer.

6. The computer program product of claim 11, wherein:
a template is provided for use in specifying tasks and requirements for preparing said multiple document sections.

7. The computer program product of claim 6, wherein:
at least a portion of the template is either obtained from a previously used template, or is specifically prepared for providing the specified software documentation package, selectively.

8. The computer program product of claim 6, wherein:
the specified database contains a plurality of said templates, and technical writer information contained in the specified database is stored in association with a corresponding one of said templates.

9. The computer program product of claim 1, wherein:
the specified database is constructed from input data provided by multiple data sources.

10. The computer program product of claim 9, wherein:
the data sources include at least one social network, and at least one enterprise data repository.

11. The computer program product of claim 1, wherein:
completing sections of said software documentation package automatically triggers revision of specified documentation components.

12. The computer program product of claim 1, wherein:
technical writers are selected automatically, by operation of an expert task mapping component.

13. A computer system for providing a specified software documentation package that comprises multiple document sections including at least a first section and a second section, said computer system comprising:
a bus;
a memory connected to the bus, wherein program code is stored on the memory; and
a processor unit connected to the bus, wherein the processor unit executes the program code to determine a set of skills that a technical writer must have in order to prepare a given one of said documents sections, wherein preparation of the first section requires a first skill set, and preparation of the second section requires a second skill set that is different from the first skill set; search a specified database to select a technical writer qualified to prepare each section of the multiple document sections, wherein the specified database contains the identities of persons qualified to be technical writers, and further contains the technical writing qualifications of each of said persons; assign preparation of a given document section to the technical writer selected for the given document section, wherein preparation of the first and second sections are assigned, respectively, to a first writer having the first skill set, and to a second writer having the second skill set; and validate each prepared document section for incorporation into said software documentation package.

14. The system of claim 13, wherein:
technical writers are selected automatically, by operation of an expert task mapping component.

15. The system of claim 13, wherein:
a template is provided for use in specifying tasks and requirements for preparing said multiple document sections.

16. The system of claim 15, wherein:
at least a portion of the template is either obtained from a previously used template, or is specifically prepared for providing the specified software documentation package, selectively.

17. The system of claim 15, wherein:
the specified database contains a plurality of said templates, and technical writer information contained in the specified database is stored in association with a corresponding one of said templates.

18. The system of claim 13, wherein:
the specified database is constructed from input data provided by multiple data sources.

19. The system of claim 18, wherein:
the data sources include at least one social network, and at least one enterprise data repository.

20. The system of claim 13, wherein:
completing sections of said software documentation package automatically triggers revision of specified documentation components.
